(19) United States
(12) Patent Application Publication
(10) Pub. No.: US 2013/0139705 A1
(43) Pub. Date: Jun. 6, 2013

(54) Pot boss

(71) Applicant: William Battaglia, North Haledon, NJ (US)

(72) Inventor: William Battaglia, North Haledon, NJ (US)

(21) Appl. No.: 13/373,914

(22) Filed: Dec. 5, 2011

(51) Int. Cl. A47J 37/12

(52) U.S. Cl. 99/355

(57) ABSTRACT

A cookware apparatus has a body having a side wall and a bottom, and includes a drain connected to the bottom of the cookware. A strainer or perforated member is disposed above the bottom of the cookware for supporting food to be cooked, and for allowing to drain the liquid without disturbing the cooked food so that only the liquid drains and the cooked food is left behind. A manual control device is disposed on one side of the cookware near the top thereof, to control the draining process.

### FIELD OF THE INVENTION

The present invention relates to cookware in general including pots and pans, and to cookware for handling and draining liquids.

### BACKGROUND OF THE INVENTION

Cookware is known for handling liquids, such as pots and pans. Cookware is also known for keeping water for heating separate from items to be cooked, such as double boiler pots and pans, and also pans having a removable perforated insert to keep food elevated above boiling liquid and/or separated from boiling liquid.

However, it is a problem in the art to drain liquid from cookware quickly and safely, without removing the food items from the cookware. A person handling ordinary cookware containing hot liquid and food can try to drain the liquid by holding the cookware over a sink and tilting the cookware so that the liquid drains out. This can be difficult to perform without splashing hot or even scalding water on the person, and it can result in spilling of food items into the sink by accident, and can even result in the cookware itself being accidentally dropped into the sink due to the difficulty in tilting it while holding it to spill liquid out.

There is a need for cookware that can safely and conveniently drain liquid therefrom without tilting of the cookware. There is also a need for cookware that allows removal of liquid from the bottom of the cookware without disturbing the cooked food above the liquid.

Further, such cookware should be stable, safe, easy to use, easy to clean, and lightweight.

Accordingly, it is a problem in the art to provide cookware meeting the above-discussed needs.

### SUMMARY OF THE INVENTION

From the foregoing, it is seen that it is a problem in the art to provide a device meeting the above requirements. According to the present invention, a device and process are provided which meets the aforementioned requirements and needs in the prior art. Specifically, the device according to the present invention provides cookware in the form of a pot or pan, which allows removal of liquid therefrom without tilting of the cookware.

More specifically, the present invention provides cookware having a drain connected to the bottom of the cookware, a strainer or perforated member disposed above the bottom of the cookware for supporting food to be cooked, and for allowing to drain the liquid without disturbing the cooked food so that only the liquid drains and the cooked food is left behind, and a manual control device disposed on one side of the cookware near the top thereof.

The manual control device includes a central button which controls release of the liquid by controlling the position of a stopper member in the bottom of the cookware. The manual control device also includes a pair of side buttons to prevent release of the central button unless both side buttons are squeezed toward each other. When the pair of side buttons are released when the central button is already depressed to open the stopper member, the release of the pair of side buttons causes the central member to remain in the depressed position.

Thus, the liquid can be partially drained by a controlled depression of the central button, or the liquid can be made to be completely drained when the central button is locked in the depressed position.

The liquid is drained from an opening formed in a side of the cookware adjacent the bottom thereof. Because the liquid is drained from the side, the cookware can be placed on a counter adjacent a sink with only a small portion of the bottom surface of the cookware over the sink, so that the cookware is very well supported by the counter. The liquid drains from the opening until the central button is returned from its depressed position to its upper position. As noted above, if the central button remains depressed long enough, nearly all of the liquid can drain from the cookware without tilting of the cookware.

Other objects and advantages of the present invention will be more readily apparent from the following detailed description when read in conjunction with the accompanying drawings.

### BRIEF DESCRIPTION OF THE DRAWINGS

FIG. 1 is a schematic side elevational view of cookware according to the present invention.

FIG. 2 is a schematic front elevational view of the cookware of FIG. 1 as viewed from the left of FIG. 1.

FIG. 3 is a schematic top elevational view of the cookware of FIGS. 1 and 2.

FIG. 4 is a schematic bottom elevational view of the cookware of FIGS. 1-3.

FIG. 5 is an enlarged view, partially in section, of an opening in the lower side portion of the cookware of FIGS. 1-4.

FIG. 6 is a side elevational view of a drainage member having a stopper, which is mounted on the interior lowermost portion of the cookware, for draining liquid from the cookware.

FIG. 7 is a side elevational view of a pivotable control element shown in FIG. 6.

FIG. 8 is a schematic top elevational view of the drainage member and pivotable control element of FIGS. 6 and 7.

FIG. 9 is a schematic top elevational view of a handle portion of the cookware of FIGS. 1-4, having a member actuated by a central button and released or secured by a pair of side buttons.

FIG. 10 is a schematic side view taken along line 10A-10A of FIG. 9, showing two positions of the actuated member of FIG. 9 from a secured “valve closed” position shown in solid outline to a secured “valve opened” position shown in dashed outline.

FIG. 11 is a schematic section view of a guard portion disposed against a wall of the cookware, and showing an actuating the rod.

FIG. 12 is a top elevational view of the removable interior member 40. Here, the perforations 42 are partially shown.

FIG. 13 is a side elevational view of the removable interior member of FIG. 12, showing supporting legs in side view.

FIG. 14 is a schematic top view of the pair of side buttons which are shown in FIGS. 1, 2, 3, and 9, being biased away from each other by a spring member.

### DETAILED DESCRIPTION OF THE INVENTION

As discussed hereinabove, cookware is known for handling liquids, such cookware including items like pots and pans. Cookware is also known for keeping water for heating separate from items to be cooked, such as double boiler pots and pans, and also pans having a removable perforated insert to keep food elevated above boiling liquid. The perforated insert is mainly used to keep food supported and left behind once the central button is depressed, opening the stopper to allow the liquid to partially or fully drain from the pot, so that no food enters the bottom of the pot and through the stopper opening.

However, there is a need to drain liquid from cookware quickly and safely, without removing the food items from the cookware. In conventional cookware, a person handling that cookware when it contains hot liquid and food can try to drain the liquid by holding the cookware over a sink and tilting the cookware so that the liquid drains out. This can be difficult to perform without splashing hot or even scalding water on the person, and it can result in spilling of food items into the sink by accident, and can even result in the cookware itself being accidentally dropped into the sink due to the difficulty in tilting it while holding it to spill liquid out. Also, some conventional cookware includes a removable perforated insert at the top of the cookware which has to be removed from the boiling water when separating the cooked food from the pot, but the pot still remains full of boiling water which will still have to be carried to the sink and tilted to drain. The Pot Boss cookware of the present invention is all-in-one.

The present invention, as shown in the drawings, addresses these needs in the prior art, and is discussed further as follows. The cookware of the present invention can be composed of any materials known to be used in the cookware arts, such as metal, ceramic, clay, high temperature plastic, and so on. These and all other variations which would be within the ambit of one having skill in the cookware arts, are contemplated as being within the scope of the present invention.

FIG. 1 is a schematic side elevational view of cookware 100, in the form of a pot or pan having a sidewall 10, a bottom wall 16, and a top edge 14. The cookware 100 also includes a handle portion 20 which supports a central button 26 and a pair of side buttons 28. The handle portion 20 has an upper portion 22 which supports the central button 26, and a lower portion 24 which supports the pair of side buttons 28.

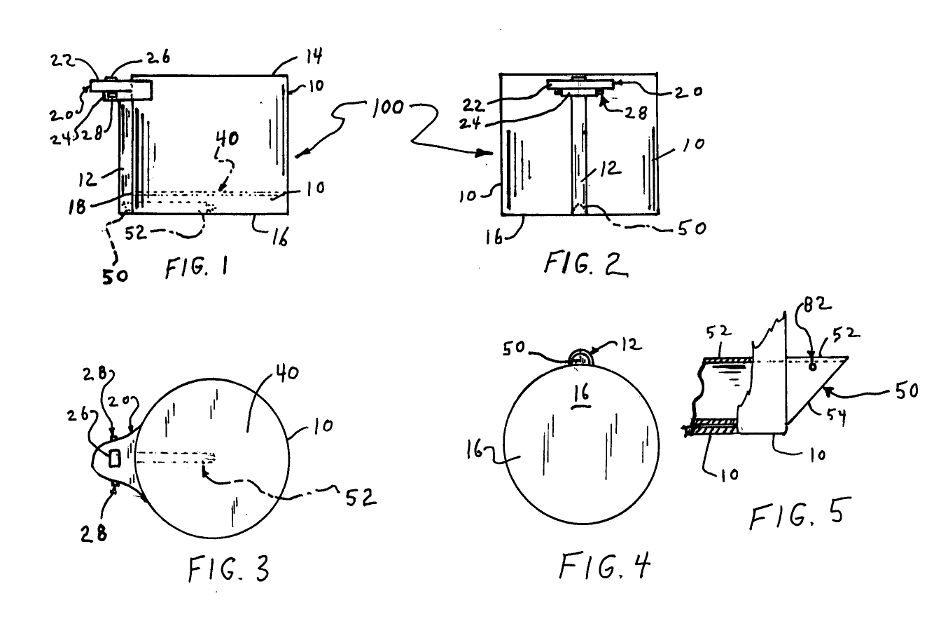

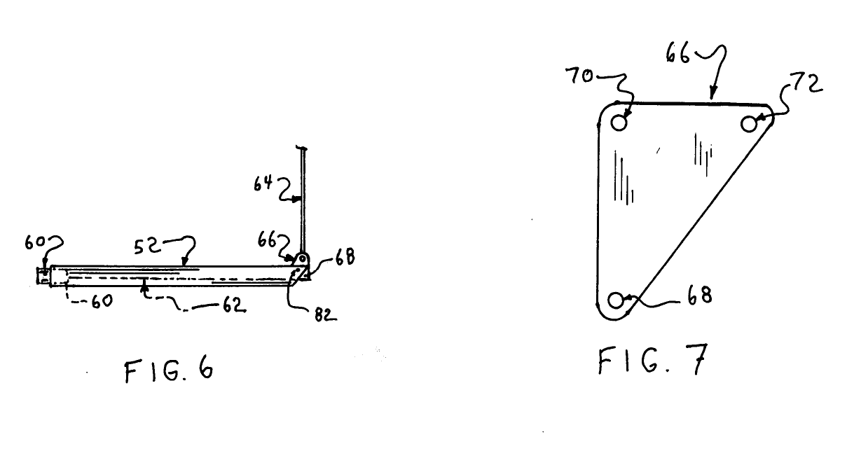

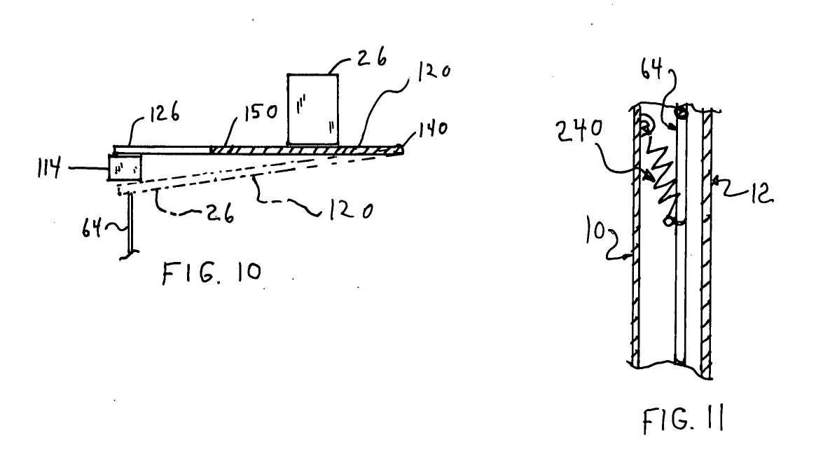

A guard portion 12 is disposed along the sidewall 10 extending from adjacent the lowermost portion of the handle portion 20 to the bottom of the cookware 100. The guard portion 12 houses a control rod 64 (shown in FIGS. 6 and 10) and covers an opening 50 (shown in FIGS. 2 and 5) in the sidewall 10. The guard portion 12 joins the sidewall 10 at an edge 18.

FIG. 1 also shows in dashed outline a removable interior member 40, which can be a perforated member having legs or a rim to raise it above the bottom wall 16. The member 40 serves to support food items and allow separation of the food items from liquid, and thus the member 40 can be a perforated sheet or a mesh sheet, or have any other known type of construction which permits liquid to flow through without allowing food items to go through. These and all other variations which would be within the ambit of one having skill in the cookware arts, are contemplated as being within the scope of the present invention.

FIG. 1 additionally shows in dashed outline a drainage member 52 which extends along the bottom wall 16 and terminates at the opening 50. While the drainage member 52 is shown as being a linear elongated member, it can have other forms and shapes, such as a spiral shape, or can be formed as a composite shape, or include a solid block which is porous and permeable to liquids. These and all other variations which would be within the ambit of one having skill in the cookware arts, are contemplated as being within the scope of the present invention.

FIG. 2 is a schematic front elevational view of the cookware 100 of FIG. 1 as viewed from the left of FIG. 1. In this view, two opposed side buttons 28 are shown. The guard portion 12 is shown in true outline, and the guard portion 12 is preferably a thin walled semi-cylindrical member. Other shapes can be used for the guard member, whose main purpose is to protect a liquid control linkage disposed therein. The opening 50 is shown in dashed outline in this view. The other numbered parts are as discussed with regard to FIG. 1 hereinabove.

FIG. 3 is a schematic top elevational view of the cookware 100 of FIGS. 1 and 2. In this view, the central button 26 can be seen, as well as the drainage member 52 shown in dashed outline. The removable interior member 40 is shown in top elevational view, and as discussed hereinabove the removable interior member 40 preferably has perforations (not shown) or is formed of mesh material or other porous material to allow liquid to pass through. The side buttons 28 are both visible in FIG. 3, as is the shape of the handle portion 20.

FIG. 4 is a schematic bottom elevational view of the cookware of FIGS. 1-3. In this view, the shape of the guard portion 12 is visible, as is the opening 50 and the bottom wall 16.

FIG. 5 is an enlarged view, partially in section, of the opening 50 disposed in the lower side portion of the cookware of FIGS. 1-4. Here, the opening 50 is formed from a pipe body 52 (the pipe body 52 constituting the drainage member discussed hereinabove) having an edge 54 formed at a slant to direct liquid outwardly and downwardly. A pin 82 is shown passing through a bore (unnumbered) in the pipe body 52. The pin supports a pivotable mechanism discussed further below.

FIG. 6 is a side elevational view of the drainage member 52 having a stopper 60, which is mounted on the interior lowermost portion of the cookware, for draining liquid from the cookware. The stopper 60 is formed as a longitudinally movable member having grooves in an elongated body portion which is adapted to slide in and out of the drainage member 52. In a closed position, the stopper 60 blocks all fluid flow, and in an opened position the stopper 60 is moved partially out of the drainage member 52 so that the exposed grooves in the body of the stopper 60 allow liquid to pass from the cookware 100 into the drainage member 52 and out the opening 50.

In FIG. 6, a pivoting mechanism 66 is shown which is actuated by a rod 64. The stopper 60 is actuated by a rod 62 which is shown in dashed outline in FIG. 6, the rod 62 being connected at a pivot point 68 on the pivoting mechanism 66. Depression of the central button 26 causes the rod 64 to move downward, which in turn causes the pivoting mechanism 66 to pivot about the pin 82 (shown in FIGS. 5 and 6), which in turn causes the pivot point 68 to move to the left as viewed in FIG. 6, thereby pushing the stopper leftward and out of the drainage member 52. An upward movement of the rod 64 causes the reverse effects, so as to move the stopper 60 to the closed position.

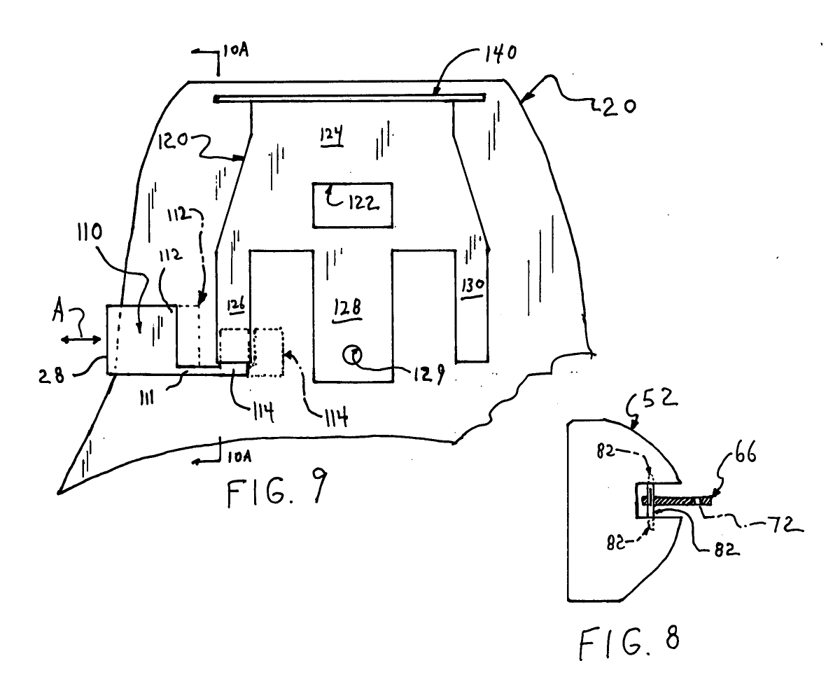

FIG. 7 is a side elevational view of the pivoting member 66, which serves as a pivotable control element and operates in the manner shown in FIG. 6. The pivoting mechanism 66 has a bore 72 which connects pivotably to the rod 64, a bore 70 to receive the pin 82, and a bore 68 which connects pivotably to the rod 62.

FIG. 8 is a schematic top elevational view of the drainage member and pivotable control element of FIGS. 6 and 7. The view is partially in section to show the bore 72 and the pin 82. This view shows the top portion of the drainage member 52 at the outlet end thereof.

FIG. 9 is a schematic top elevational view of the handle portion 20 of the cookware 100 of FIGS. 1-4, having a member 120 which is actuated by the central button 26 (not shown in this view) and released or secured by the pair of side buttons 28. In this view, only one of the side buttons 28 is shown; the other one is omitted for the sake of clarity.

In FIG. 9, the member 120 is pivotably mounted by a pin portion 140, and is disposed over a cavity or recess formed in the handle portion 20. The ends of the pin portion 140 are secured in the handle portion 20 for pivoting motion, and combined with the above-mentioned recess in the handle portion 20, permits the member 120 to move downwardly and upwardly. The member 120 has a body portion 124 which includes two side legs 126 and 130 disposed on either side of a longer center leg 128. The center leg 128 has a bore 129 therein for connection to the rod 64. A cover (not shown in FIG. 9) is provided to cover the elements shown in FIG. 9.

The side button 28 can move in the directions indicated by the double-headed arrow A in FIG. 9. The side button 28 has a main portion 110 which has an end exposed during use for manual actuation, a neck portion 111, and a stop portion 114. In the position shown in FIG. 9 the stop portion is disposed below the leg 126 and thereby secures the member 120 against downward motion. Thus, in this position, the button 26 cannot be depressed because it sits atop the leg portion 128 and, inasmuch as the member 120 cannot move downward while the stop portion 114 is below the leg 126, there can be no accidental discharge of liquid from the cookware 100.

However, when the button 28 is moved to the right as viewed in FIG. 9 so that the stop portion 114 is in the position indicated by the dashed outline, the leg 126 is not longer stopped from moving downward, and thus the button 26 can be depressed to actuate the linkage which opens the drainage member 52 to discharge liquid. Since there are two such buttons 28 (the second button 28 operating relative to the leg 130 in a similar manner to that described hereinabove for the leg 126), both such buttons 28 must be depressed at the same time to allow the button 26 to be depressed.

When the button 26 is depressed, the pair of buttons 28 can continue to be pressed, so that the discharge of liquid is controlled by the operator of the cookware and who can stop the discharge of the liquid simply by releasing the button 26. However, when the member 120 is depressed and the buttons 28 are released, the stop portions 114 will be disposed above the legs 126 and 130 (shown in FIG. 10) so as to block the member 120 from rising; this serves to lock the drainage member 52 in a discharge position, so that the cookware 100 will automatically drain fully even when left by itself.

FIG. 10 is a schematic side view taken along line 10A-10A of FIG. 9, showing two positions of the actuated member of FIG. 9 from a secured “valve closed” position shown in solid outline to a secured “valve opened” position shown in dashed outline. Here, the rod 64 is connected pivotably to the member 120. The leg 126 is seen above the stop portion 114 in the closed position shown in solid outline, and the leg 126 is seen below the stop portion 114 in the open position shown in dashed outline. The button 26 is shown disposed above the member 120 for direct contact therewith. The button 26 is constrained by the cover member mentioned hereinabove, which is not shown, so as to move only upwardly and downwardly without falling out of the cover. This can be done in any known manner, and all other variations which would be within the ambit of one having skill in the cookware arts, are contemplated as being within the scope of the present invention.

FIG. 11 is a schematic section view of the guard portion 12 disposed against the wall 10, showing the rod 64. In this view, a spring member 240 is connected at one end thereof to the wall 10, and is connected at the other end thereof to a portion of the rod 64. The spring member 240 biases the rod 64 to the closed position, so that the button 26 will normally be in a raised position when the drainage member 52 is in a closed position. The rod 64 will return to the closed position when allowed to do so, under the influence of the spring member 240.

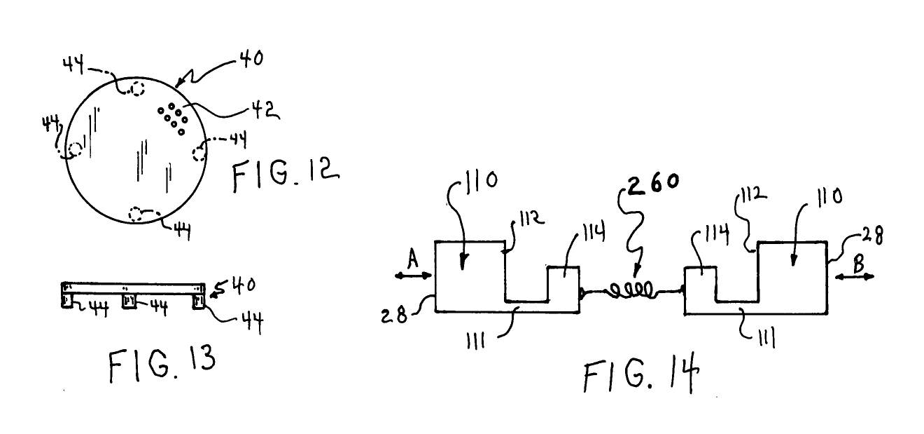

FIG. 12 is a top elevational view of the removable interior member 40. Here, the perforations 42 are partially shown. A plurality of legs 44 are shown in dashed outline in this view.

FIG. 13 is a side elevational view of the removable interior member 40 of FIG. 12. Here, the legs 44 are shown in side view. Other methods and devices are contemplated as being within the scope of the present invention, for supporting the removable interior member 40 above the drainage member 52. Such variations could include other types of leg members, or can include a ledge built into the interior portion of the side wall 10. Another variation would be simply having the side wall 10 taper so that it narrows in a downward direction so that the tapering region supports the removable interior member 40.

FIG. 14 is a schematic top view of the pair of side buttons 28, 28 which are shown in FIGS. 1, 2, 3, and 9, being biased away from each other by a spring member 260. The elements numbered in this view are as shown and described with reference to FIG. 9, discussed hereinabove. Such spring biasing devices and means are well known in the push button arts. Further, it is understood that the buttons 28, 28 are supported so as to be guided in the linear directions A and B, as shown in FIG. 14.

The dimensions set forth above are by way of example only, and these dimensions can vary without departing from-the scope of the present invention.

The invention being thus described, it will be evident that the same may be varied in many ways. Such variations are not to be regarded as a departure from the spirit and scope of the invention and all such modifications are intended to be included within the scope of the claims.

What is claimed is:

1. A cooking apparatus for cooking food and separating liquid from the food, comprising:
a body having a bottom wall and an upstanding side wall, said bottom wall and said upstanding side wall defining an interior region of the body;
a handle portion connected to said body;
a drain member disposed adjacent said bottom wall, said drain member communicating with said interior region of said body, and having an outlet orifice;
a controllable stopper for selectively opening and closing said outlet orifice of said drain member;
an interior member disposed above said drain member; and
an actuator supported by said handle portion, for actuating said controllable stopper.

2. A cooking apparatus as claimed in claim 1, wherein said handle portion includes a first push button for manual operation of said actuator.

3. A cooking apparatus as claimed in claim 2, where said handle portion includes a releasable securing member for securing said first push button against actuation.

4. A cooking apparatus as claimed in claim 3, further comprising at least a second push button for releasing said releasable securing member, such that depression of said second push button releases said first push button to allow actuation of said controllable stopper.

5. A cooking apparatus as claimed in claim 3, further comprising a second push button and a third push button for releasing said releasable securing member only when both of said second and third push buttons are actuated, such that depression of said second and third push buttons releases said first push button to allow actuation of said controllable stopper.

6. A cooking apparatus as claimed in claim 5, wherein said handle portion includes a movable element which is actuated by said first push button.

7. A cooking apparatus as claimed in claim 6, further comprising an outlet orifice in said side wall in communication with said drain member.

8. A cooking apparatus as claimed in claim 7, further comprising an actuator rod connected to said movable element.

9. A cooking apparatus as claimed in claim 8, further comprising a stopper actuator arm which is connected to said stopper.

10. A cooking apparatus as claimed in claim 9, further comprising a pivot mechanism supported at said outlet orifice, having one pivot end connected to said actuator rod and having another pivot end connected to said stopper actuator arm.

11. A cooking apparatus as claimed in claim 10, further comprising a guard portion covering said actuator rod.

12. A cooking apparatus as claimed in claim 11, wherein said guard portion is a curved member having two edges, each of said two edges being secured against an outer side of said side wall so as to enclose said actuator rod.

13. A cooking apparatus as claimed in claim 12, wherein said drain member extends through said outlet orifice to form a drainage outlet.

14. A cooking apparatus as claimed in claim 13, wherein said drainage outlet of said drain member has a slanted portion opening downwardly.

15. A cooking apparatus as claimed in claim 14, wherein said drainage Outlet has an upper portion having a bore, and further comprising a pivot pin passing through said bore, said pivot pin and said drainage outlet pivotably supporting said pivot mechanism.

16. A pan for cooking food and for separating liquid from the food, comprising:
a body having a bottom wall and an upstanding side wall, said bottom wall and said upstanding side wall defining an interior region of the body;
a handle portion connected to said body;
a drain member disposed adjacent said bottom wall, said drain member communicating with said interior region of said body, and having an outlet orifice;
a controllable stopper for selectively opening and closing said outlet orifice of said drain member;
an interior member disposed above said drain member; and
an actuator supported by said handle portion, for actuating said controllable stopper; and
wherein said handle portion includes a first push button for manual operation of said actuator;
whereby manual operation of said actuator enables liquid to drain out of the interior region of the body.

17. A cooking apparatus as claimed in claim 16, where said handle portion includes a releasable securing member for securing said first push button against actuation.

18. A cooking apparatus as claimed in claim 17, further comprising a second push button and a third push button for releasing said releasable securing member only when both of said second and third push buttons are actuated, such that depression of said second and third push buttons releases said first push button to allow actuation of said controllable stopper.

19. A cooking apparatus as claimed in claim 18, wherein said handle portion includes a movable element which is actuated by said first push button.

20. A cooking apparatus as claimed in claim 19, further comprising an outlet orifice in said side wall in communication with said drain member.
